(19) United States
(12) Patent Application Publication
(10) Pub. No.: US 2014/0176109 A1
(43) Pub. Date: Jun. 26, 2014

(54) SOLAR POWER SUPPLY DEVICE

(71) Applicant: HON HAI PRECISION INDUSTRY CO., LTD., New Taipei (TW)

(72) Inventors: CHUANG-WEI TSENG, New Taipei (TW); CHE-HSUN CHEN, New Taipei (TW)

(73) Assignee: HON HAI PRECISION INDUSTRY CO., LTD., New Taipei (TW)

(21) Appl. No.: 14/083,465

(22) Filed: Nov. 19, 2013

(30) Foreign Application Priority Data
Dec. 25, 2012 (TW) 101149727

(51) Int. Cl. H02M 3/02

(52) U.S. Cl. CPC H02M 3/02
USPC 323/299

(57) ABSTRACT

A solar power supply device includes a solar panel converting solar energy to electrical power with a DC voltage, a voltage convertor connected to the solar panel, a control unit, and a PWM signal processing unit. The voltage convertor converts the DC voltage to a power voltage to power the electrical equipment. The control unit outputs a first and a second PWM signal, and adjusts duty cycles of the first PWM signal and/or the second PWM signal by determining whether the electrical power output by the solar panel can drive the electrical equipment. The PWM signal processing unit multiplies the first PWM signal and the second PWM signal to obtain a third PWM signal, and output the third PWM signal to the voltage convertor to control the voltage convertor to output the corresponding power voltage.

### BACKGROUND

1. Technical Field

The present disclosure relates to power supply devices, particularly, to a solar power supply device.

2. Description of Related Art

Nowadays, clean energy, such as solar power, is widely utilized. Usually, electrical equipment powered by a solar power supply device is also connected to an alternating current (AC) power grid. When the solar power supply device cannot power the all of electric equipment, the AC power grid would supplement the power provided to the electric equipment. Therefore, in order to utilize the solar energy, the solar power supply device should output a maximum power. However, the maximum power changes due to the amount of solar energy being absorbed being changing, and the voltage output to the electric equipment should be maintained to a constant value to avoid being damaged. Thus, it is necessary to stabilize the voltage output of the solar power supply device. A conventional solar power supply device includes two stages of convertors, a first convertor is used to track the maximum power according to a first pulse-width modulation (PWM) signal with a first frequency, and the second convertor is used to stabilize the voltage according to a second PWM signal with a second frequency. However, the cost of such a solar power supply device is high when using two convertors.

A solar power supply device to overcome the described limitations is thus needed.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a block diagram of a solar power supply device, in accordance with a first embodiment.

FIG. 2 is a schematic diagram of a pulse-width modulation signal output by a control unit of the solar power supply device of FIG. 1, in accordance with a first embodiment.

### DETAILED DESCRIPTION

Embodiments of the present disclosure will be described with reference to the accompanying drawings. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

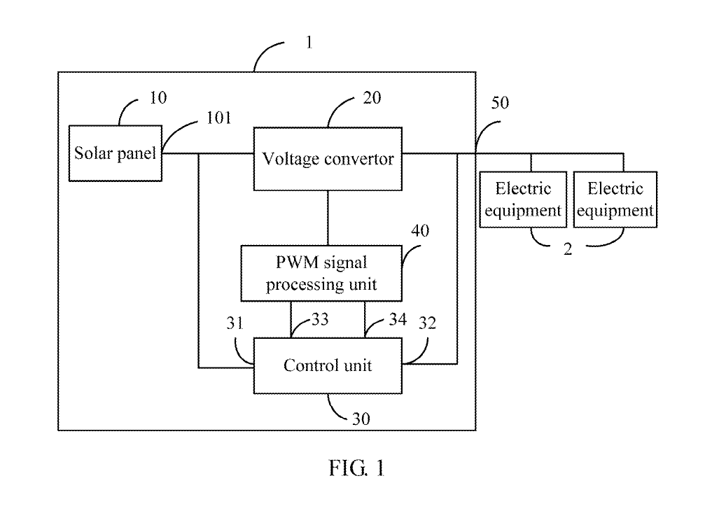

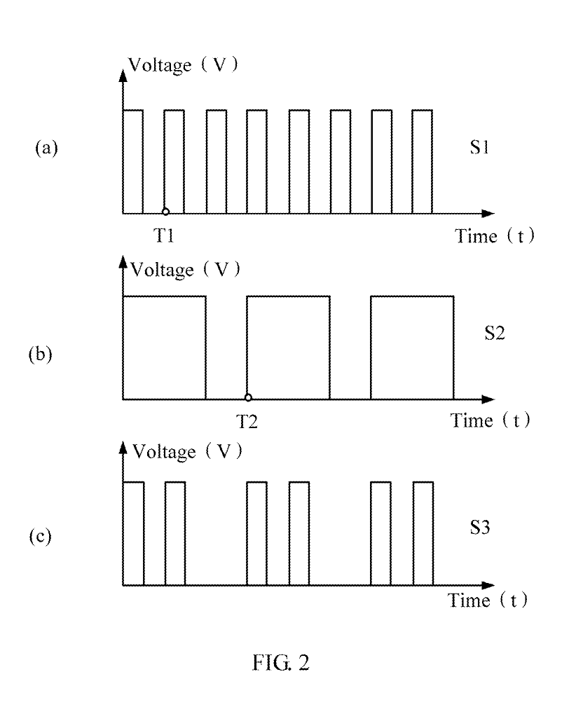

FIGS. 1 and 2 together show a solar power supply device 1 of an illustrated embodiment. The solar power supply device 1 includes a solar panel 10, a voltage convertor 20, a control unit 30, a pulse-width modulation (PWM) signal processing unit 40, and a power port 50.

The solar panel 10 is used to convert the solar energy of sunlight to an electrical power. In the illustrated embodiment, the solar panel 10 converts the solar energy to the electrical power with a direct current (DC) voltage. The power port 50 is used to connect to electric equipment 2, such as computers, TV sets, and air conditioners.

The voltage convertor 20 is connected between the solar panel 10 and the power port, and is used to convert the DC voltage to a power voltage and then output the power voltage to the electrical equipment 2 via the power port 50.

The control unit 30 is used to output a first PWM signal S1 and a second PWM signal S2, and adjust duty cycles of the first PWM signal S1 and/or the second PWM signal S2 by determining whether the electrical power output by the solar panel 10 can drive the electrical equipment 2 connected to the power port 50.

The PWM signal processing unit 40 is connected between the control unit 30 and the voltage convertor 20, the PWM signal processing unit 40 processes the first PWM signal S1 and the second PWM signal S2 output by the control unit 30 to obtain a third PWM signal S3. The PWM signal processing unit 40 then outputs the third PWM signal S3 to the voltage convertor 20, the voltage convertor 20 output the corresponding power voltage according to the received third PWM signal S3. In the embodiment, the PWM signal processing unit 40 executes a AND operation to the first PWM signal S1 with the second PWM signal S2, namely, the PWM signal processing unit 40 multiplies the first PWM signal S1 with the second PWM signal S2 to obtain the third PWM signal S3.

The control unit 30 includes a first detection port 31, a second detection port 32, a first PWM power port 33, and a second PWM power port 34. The solar panel 10 includes an output port 101, the output port 101 is connected to the voltage convertor 20 and outputs the DC voltage to the voltage convertor 20. The first detection port 31 is connected to the output port 101 of the solar panel 10, the second detection port 32 is connected to the power port 50. The control unit 30 detects the electrical power output by the solar panel 10 via the first detection port 31 and detects a consuming power of the electrical equipment 2 via the second detection port 32. The first PWM power port 33 is used to output the first PWM signal S1 and the second PWM power port 34 is used to output the second PWM signal S2.

In the embodiment, as shown in FIG. 2, the frequency of the first PWM signal S1 is greater than that of the second PWM signal S2, namely, a period T1 of the first PWM signal S1 is less than a period T2 of the second PWM signal S2.

The control unit 30 compares the electrical power output by the solar panel 10 and the consuming power of the electric equipment 2 to obtain a comparison result, and adjusts the duty cycles of the first PWM signal S1 and the second PWM signal S2 according to the comparison result. In detail, when the control unit 30 determines the comparison result is that the electrical power output by the solar panel 10 is less than the consuming power of the electric equipment 2, the control unit 30 determines the electrical power output by the solar panel 10 cannot drive the electric equipment 2, the control unit 30 adjusts the duty cycle of the second PWM signal S2 to 100%. Namely, the control unit 30 controls the second PWM signal S2 to a high voltage signal. Thus, the third PWM signal S3 is equal to the first PWM signal S1 now. The control unit 30 then adjusts the duty cycle of the first PWM signal S1 with the relative higher frequency to track a maximum electrical power output by the solar panel 10. The method to track the maximum power is well known, and a description any further is not necessary.

When the control unit 30 determines the comparison result is that the electrical power output by the solar panel 10 is greater than or equal to the consuming power of the electric equipment 2, the control unit 30 determines the electrical power output by the solar panel 10 can drive the electric equipment 2, the control unit 30 adjusts the duty cycle of the first PWM signal S1 to 100%. Namely, the control unit 30 controls the first PWM signal S1 to a high voltage signal. Thus, the third PWM signal S3 is equal to the second PWM signal S2 now. The control unit 30 then adjusts the duty cycle of the second PWM signal S2 with the relative lower frequency to the voltage convertor 20 to ensure the power voltage output by the voltage convertor 20 is stable. In the embodiment, the voltage convertor 20 can be a switch power unit. The power voltage output by the voltage convertor 20 is adjusted by adjusting the duty cycle of the second PWM signal S2. The method to ensure the power voltage output by the voltage convertor 20 is stable is also well known, and a description any further is not necessary.

In detail, as shown in FIG. 2, the period of the first PWM signal S1 is T1 and the period of the second PWM signal S2 is T2, and the period T1 is less than the period T2. Thus the frequency of the first PWM signal S1 is greater than that of the second PWM signal S2. The third PWM signal S3 is multiplied by the first PWM signal S1 and the second PWM signal S2 as shown in FIG. 2.

If the first PWM signal S1 is always at high voltage, the third PWM signal S3 multiplies by the first PWM signal S1 and the second PWM signal S2 is equal to the second PWM signal S2. When the second PWM signal S2 is always at high voltage, the third PWM signal S3 multiplies by the first PWM signal S1 and the second PWM signal S2 is equal to the first PWM signal S1.

In the illustrated embodiment, the PWM signal processing unit 40 is a logic AND gate circuit.

In the illustrated embodiment, the electrical power output by the solar panel 10 includes the DC voltage and a DC current, the control unit 30 detects the DC voltage and the DC current output by the solar panel 10 via the first detection port 31. The control unit 30 then obtains the electrical power output by the solar panel 10 by multiplying to the DC voltage and the DC current. For example, if the DC voltage is V1 and the DC current is C1, then the electrical power output by the solar panel 10 is V1*C1. The controls 30 also detects a voltage and a current output by the power port 50 via the second detection port 32, and obtains the consuming power of the electrical equipment 2 by multiplying the voltage and the current output by the power port 50.

In the present disclosure, there is only need one voltage convertor 20, which can achieve the function of tracking the maximum power and stabilizing the voltage.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A solar power supply device comprising:
a solar panel configured to convert solar energy of sunlight into electrical power with a direct current (DC) voltage;
a power port configured to connect to electrical equipment;
a voltage convertor connected between the solar panel and the power port, and configured to convert the DC voltage to a power voltage and then output the power voltage to the electrical equipment via the power port;
a control unit configured to output a first pulse-width modulation (PWM) signal and a second PWM signal, and adjust duty cycles of the first PWM signal and/or the second PWM signal by determining whether the electrical power output from the solar panel can drive the electrical equipment; and
a PWM signal processing unit connected between the control unit and the voltage convertor, and configured to multiply the first PWM signal and the second PWM signal output from the control unit to obtain a third PWM signal, and output the third PWM signal to the voltage convertor to control the voltage convertor to output the power voltage.

2. The solar power supply device according to claim 1, wherein the control unit comprises a first detection port, a second detection port, a first PWM power port, and a second PWM power port, the solar panel comprises an output port; the first detection port is connected to the output port of the solar panel, the second detection port is connected to the power port, the control unit detects the electrical power output by the solar panel via the first detection port and detects a consuming power of the electrical equipment via the second detection port; the first PWM power port is configured to output the first PWM signal and the second PWM power port is configured to output the second PWM signal.

3. The solar power supply device according to claim 2, wherein when the control unit determines the electrical power output by the solar panel is less than the consuming power of the electrical equipment, the control unit adjusts the duty cycle of the second PWM signal to 100%, the third PWM signal is equal to the first PWM signal now, the control unit then adjusts the duty cycle of the first PWM signal to track a maximum electrical power output by the solar panel.

4. The solar power supply device according to claim 2, wherein when the control unit determines the electrical power output by the solar panel is greater than or equal to the consuming power of the electrical equipment, the control unit adjusts the duty cycle of the first PWM signal to 100%, the third PWM signal is equal to the second PWM signal now; the control unit then adjusts the duty cycle of the second PWM signal to stabilize the power voltage output by the voltage convertor.

5. The solar power supply device according to claim 1, wherein the voltage convertor is a switch power unit and the power voltage output by the voltage convertor is adjusted by adjusting the duty cycle of the second PWM signal output to the voltage convertor.

6. The solar power supply device according to claim 1, wherein the PWM signal processing unit is a logic AND gate circuit.

7. The solar power supply device according to claim 1, wherein a frequency of the first PWM signal is greater than a frequency of the second PWM signal.

8. The solar power supply device according to claim 2, wherein the electrical power output by the solar panel further comprises a DC current, the control unit detects the DC voltage and the DC current output by the solar panel via the first detection port and obtains the electrical power output by the solar panel by multiplying to the DC voltage and the DC current.

9. The solar power supply device according to claim 2, wherein the control unit detects a voltage and a current output by the power port via the second detection port, and obtains the consuming power of the electrical equipment by multiplying the voltage and the current output by the power port.
